(19) United States
(12) Patent Application Publication
(10) Pub. No.: US 2025/0242368 A1
(43) Pub. Date: Jul. 31, 2025

(54) HOSE END SPRAYER FOR WET OR DRY CHEMICALS

(71) Applicant: H.D. Hudson Manufacturing Company, Lowell, MI (US)

(72) Inventors: Alexander Reed, Grand Rapids, MI (US); Robert A. Thelen, Middleville, MI (US)

(21) Appl. No.: 19/037,178

(22) Filed: Jan. 25, 2025

Related U.S. Application Data
(60) Provisional application No. 63/626,265, filed on Jan. 29, 2024.

(51) Int. Cl. B05B 12/00; B05B 7/24

(52) U.S. Cl. CPC B05B 12/002; B05B 7/2424; B05B 7/2443

(57) ABSTRACT

A sprayer configured to spray a chemical in a wet mode or a dry mode includes a tank adapted to store the chemical, and a sprayer head removably coupled to the tank. The sprayer head includes a cap portion arranged to cover an opening of the tank, a channel arranged above the cap portion and configured to facilitate a flow of motive fluid therethrough, a nozzle arranged inside the channel, and a dial arranged between the channel and the cap portion. The dial is configured to rotate relative to the cap portion and the channel, and includes a plurality of first orifices, a second orifice, and a slot. The first orifices enable chemical flow from the tank to the channel in wet mode. The second orifice allows motive fluid passage into the tank in dry mode. The slot enables air entry through the cap portion in wet mode.

### CROSS-REFERENCE TO RELATED APPLICATIONS

This application claims priority to U.S. Application No. 63/626,265, filed Jan. 29, 2024, which is hereby incorporated by reference in its entirety.

### BACKGROUND

### 1. Field of the Invention

The present disclosure relates to hose end sprayers, and more particularly to a hose end sprayer configured to be operated for use with either a wet chemical or a dry chemical.

### 2. Description of the Prior Art

Sprayers, such as hose end sprayers, are commonly used for applying various chemicals in residential, agricultural, and industrial settings. These devices typically attach to a garden hose or other water source and mix the chemical with water before dispensing. Hose end sprayers are valued for their convenience and ability to quickly cover large areas with diluted chemical solutions.

Traditionally, hose end sprayers have been designed to work with either liquid (wet) chemicals or dry (solid) chemicals, but rarely both. This limitation often requires users to purchase and maintain multiple sprayers for different types of chemicals, leading to increased costs and storage requirements. Additionally, many existing sprayers that can handle both wet and dry chemicals involve complex mechanisms or multiple valves, making them prone to user error and mechanical failure.

Another challenge with conventional hose end sprayers is achieving consistent and accurate dilution rates, especially when switching between wet and dry chemical applications. Users often struggle to properly adjust the sprayer settings to achieve the desired concentration, potentially leading to over-application or under-application of chemicals. This issue is particularly problematic in agricultural and lawn care applications where precise chemical dosing is critical for effective treatment and environmental safety.

Furthermore, many existing sprayers suffer from issues related to air entrapment and pressure equalization when operating with liquid chemicals. Without proper venting, these sprayers can develop vacuum conditions within the chemical container, impeding the flow of liquid and reducing overall performance. Conversely, when used with dry chemicals, ensuring adequate water flow into the container to dissolve the product can be challenging with current designs.

### SUMMARY

According to an aspect of the present disclosure, a sprayer configured to spray a chemical in either a wet mode or a dry mode is provided. The sprayer includes a tank adapted to store the chemical, and a sprayer head removably coupled to the tank. The sprayer head includes a cap portion arranged to cover an opening of the tank, the cap portion including a first cap port and a second cap port. The sprayer head also includes a channel arranged above the cap portion and configured to facilitate a flow of motive fluid therethrough, the channel defining a first port aligned with the first cap port and a second port aligned with the second cap port.

The sprayer head further includes a nozzle arranged inside the channel and having a convergent portion to increase velocity of the motive fluid and decrease pressure of motive fluid downstream of the nozzle, thereby resulting in a pressure difference between the channel downstream of the nozzle and the tank to pull the liquid chemical from the tank inside the channel at a location downstream of the nozzle through the first port, wherein the second port is arranged upstream of the nozzle.

Additionally, the sprayer head includes a dial arranged between the channel and the cap portion, the dial being configured to rotate relative to the cap portion and the channel. The dial includes a plurality of first orifices arrayed circularly at a first radial distance from a central axis of the dial, the plurality of first orifices being configured to align with the first port and the first cap port to enable a flow of the chemical from the tank to the channel. The dial also includes a second orifice arranged at a second radial distance from a central axis of dial, wherein the second orifice is aligned with the second port and the second cap port to allow a passage of the motive fluid into the tank from the channel to operate the sprayer in the dry mode.

Furthermore, the dial includes a slot extending arcuately around the central axis of the dial and arranged at the second radial distance from the central axis and facing the cap portion, wherein the second orifice is disposed between ends of the slot. In the wet mode, the slot is aligned with the second port and the second cap port and enables an entry of air present between the cap portion and the dial through the second cap port.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates a perspective view of a hose end sprayer having a dial, in accordance with an embodiment of the disclosure;

FIG. 2A illustrates a sectional view of the hose end sprayer of FIG. 1 depicting the dial arranged to operate the sprayer in a wet mode, in accordance with an embodiment of the disclosure;

FIG. 2B illustrates an enlarged sectional view of the hose end sprayer of FIG. 1 with the handle and tank omitted, in accordance with an embodiment of the disclosure;

FIG. 3 illustrates a top perspective view of the dial of the hose end sprayer depicting a plurality of first orifices, in accordance with an embodiment of the disclosure;

FIG. 4 illustrates a bottom perspective view of the dial of FIG. 3 depicting an arcuate slot and a second orifice, in accordance with an embodiment of the disclosure; and

FIG. 5 illustrates a sectional view of the dial of FIG. 3 depicting the slot, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a hose end sprayer configured for versatile operation with both liquid and dry chemical formulations. The sprayer provides a convenient and efficient means of applying various types of chemicals, such as fertilizers, pesticides, or herbicides, using a standard water hose as the motive fluid source. By incorporating a novel design, the sprayer may be easily switched between wet and dry modes of operation without requiring separate dedicated sprayers for each type of chemical formulation. This dual-mode functionality allows users to utilize a single device for multiple applications, reducing equipment needs and simplifying chemical application processes. The sprayer's design prioritizes ease of use while maintaining reliable performance across different chemical types and application scenarios.

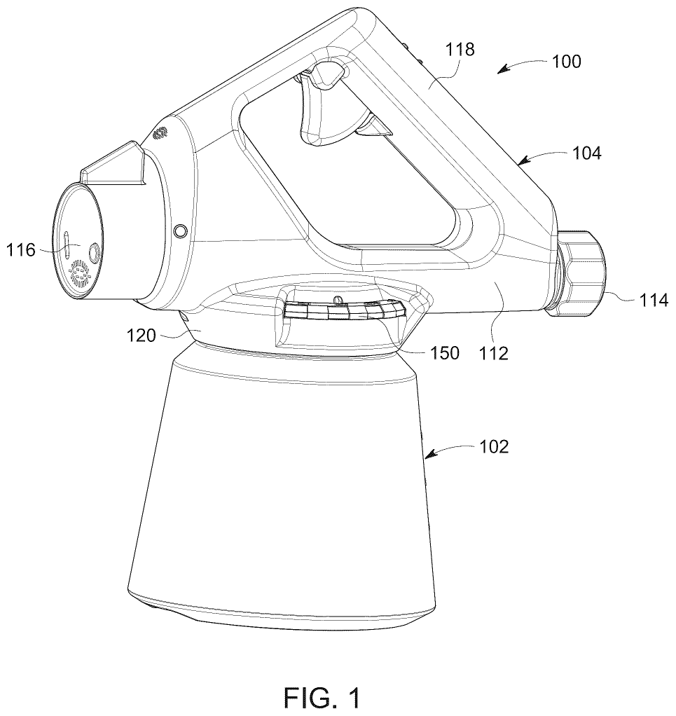

Referring to FIG. 1, a sprayer 100 configured to spray a chemical is shown. The sprayer 100 includes a tank 102 configured to store a chemical, and a sprayer head 104 removably coupled to the tank 102 to enable the chemical stored inside the tank 102 to be sprayed. The chemical may be provided in either a dry or solid form (for example, as a powder, granular, or the like), or a liquid form. Accordingly, the sprayer 100 may be adapted to be operated in a dry mode or a wet mode to spray the appropriate type of chemical.

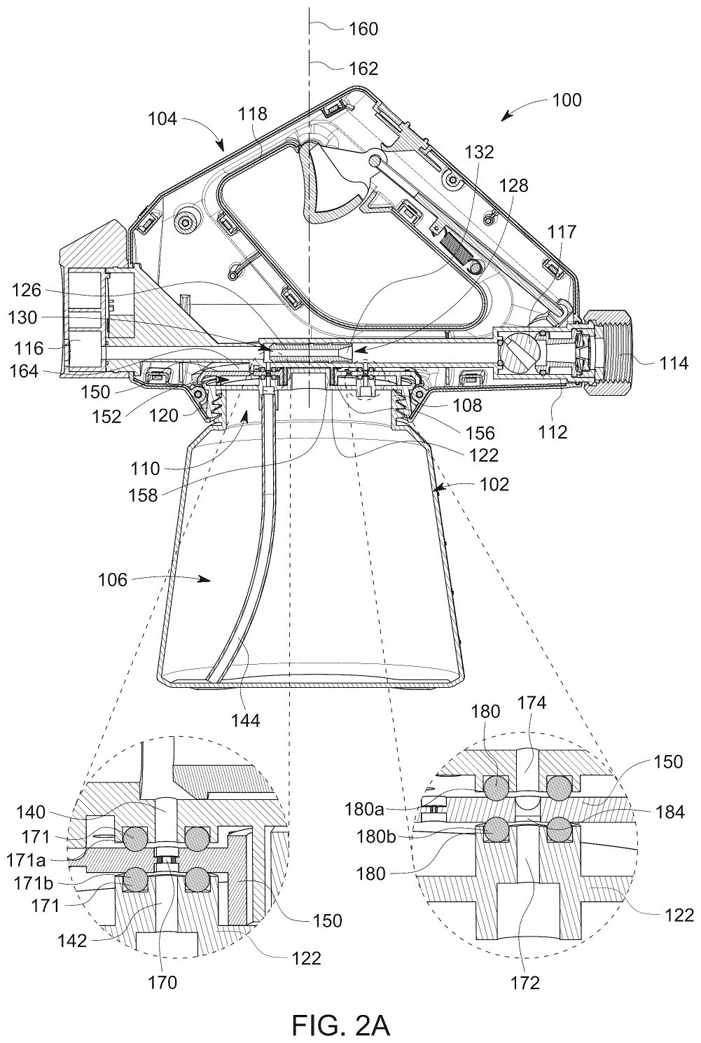

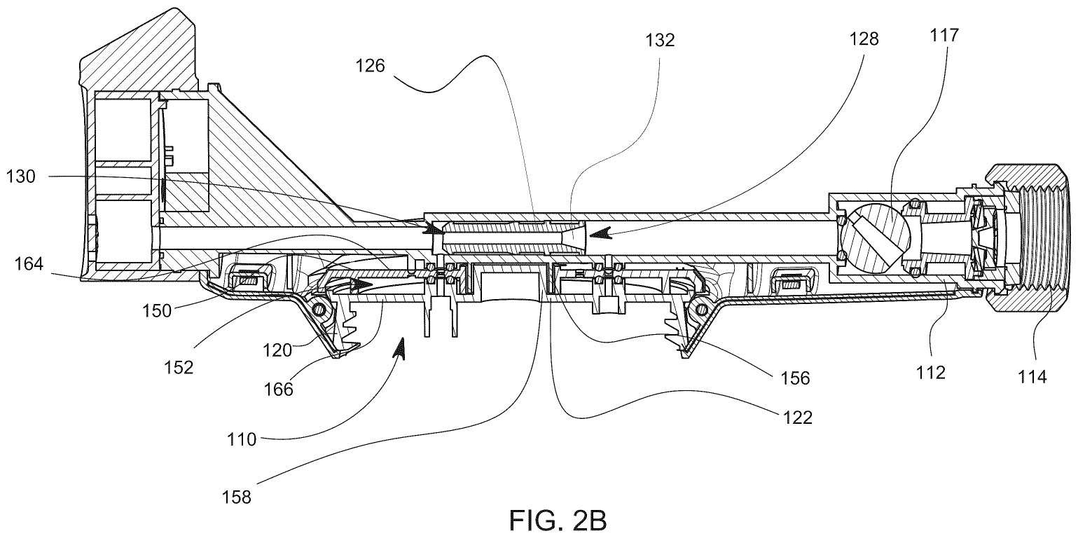

As shown in FIG. 2A, the tank 102 defines a chamber 106 to store the chemical. The tank 102 includes a neck portion 108 defining an opening 110 of the chamber 106. The opening 110 has a central axis 162. The sprayer head 104 may be removably engaged with the neck portion 108. In some cases, the sprayer head 104 and the neck portion 108 are threadingly connected.

The sprayer head 104 includes a connector 120 adapted to be coupled to the neck portion 108 of the tank 102. The connector 120 includes a cap portion 122 arranged to cover the opening 110 of the chamber 106.

In some cases, the sprayer head 104 may include a tube 144 connected to the cap portion 122. The tube 144 may extend downwardly into the tank 102. The tube 144 may facilitate the flow of chemical from the chamber 106 to the sprayer head 104.

Based upon the foregoing disclosure, it is seen that the present disclosure provides a sprayer that can be easily configured for use with both wet and dry chemicals. The sprayer surpasses the prior art because it utilizes a simple dial mechanism to switch between wet and dry modes, eliminating the need for separate valves or additional components. This design reduces the potential for user error and improves reliability by minimizing the number of parts that must remain watertight. Additionally, the sprayer's intuitive operation and versatility make it more user-friendly and cost-effective compared to previous designs that were limited to either wet or dry chemicals exclusively.

Referring to FIG. 2A and FIG. 2B, the sprayer head 104 includes a channel 112 configured to facilitate a flow of motive fluid through the sprayer head 104. The channel 112 may have an inlet 114 to receive the motive fluid, for example water, from a source such as a garden hose. The channel 112 may also include an outlet 116 to enable the exit of a mixture of the motive fluid and the chemical from the channel 112.

The sprayer head 104 may include a nozzle 126 arranged inside the channel 112. The nozzle 126 may have an inlet port 128 and an outlet port 130. In some cases, the outlet port 130 may be arranged distally to the inlet 114 of the channel 112 relative to the inlet port 128. The nozzle 126 may be disposed substantially centrally within the channel 112 such that the nozzle 126 is positioned directly above the cap portion 122 of the connector 120.

The nozzle 126 may include a convergent portion 132 that extends from the inlet port 128 towards the outlet port 130. The convergent portion 132 may have a decreasing cross-sectional area from the inlet port 128 towards the outlet port 130. This configuration may increase the velocity of the motive fluid as the motive fluid flows through the convergent portion 132 from the inlet port 128. Consequently, the pressure of the motive fluid may decrease along the convergent portion 132.

In some cases, the pressure of the motive fluid at the outlet port 130 of the nozzle 126 may be less than the pressure at the inlet port 128 of the nozzle 126. This pressure difference may create a pressure differential between the chamber 106 and the outlet port 130, which may draw the chemical from the tank 102 into the channel 112.

To facilitate the flow of chemical from the chamber 106 to the channel 112, a first port 140 may be defined through a wall of the channel 112. The first port 140 may be arranged proximate to the outlet port 130 of the nozzle 126 and may be located outside the nozzle 126 in an axial direction of the channel 112.

The channel 112 may also include a second port 174. In some cases, the second port 174 may be arranged upstream of the nozzle 126. The second port 174 may allow a portion of the motive fluid to be directed inside the chamber 106 from a location upstream of the inlet port 128 of the nozzle 126 when the sprayer 100 is operated in a dry mode for solid chemicals.

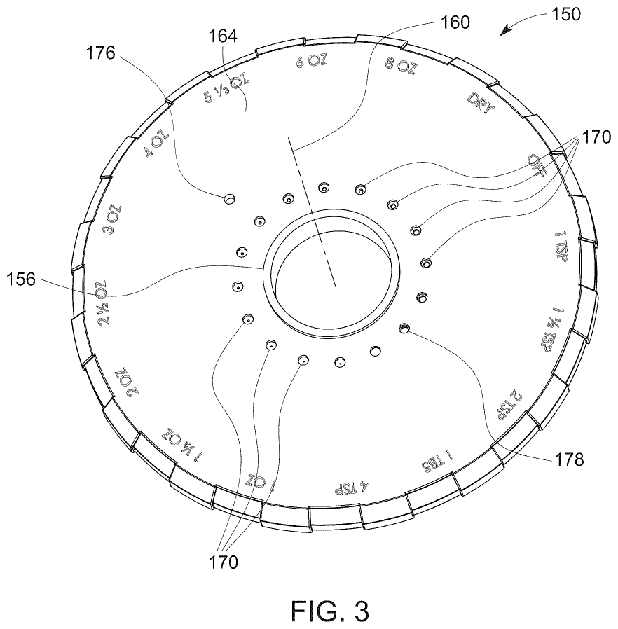

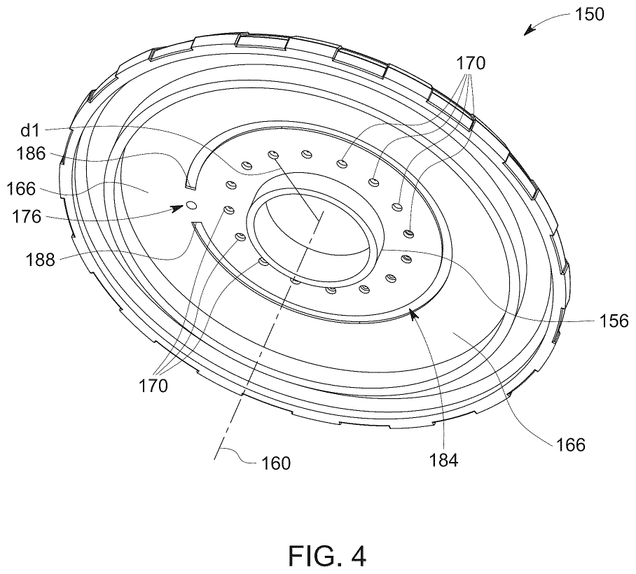

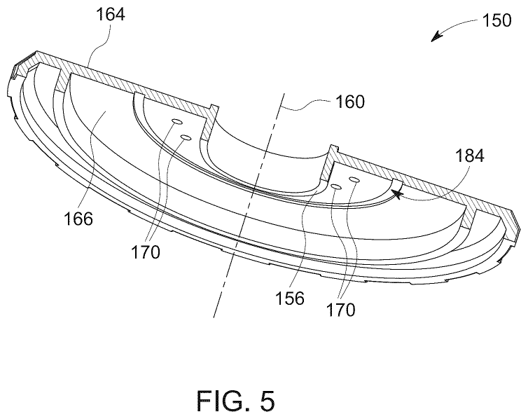

The sprayer head 104 includes a dial 150 arranged between the channel 112 and the cap portion 122. As shown in FIG. 3, FIG. 4, and FIG. 5, the dial 150 may be configured to rotate relative to the cap portion 122 and the channel 112. The dial 150 includes a dial central axis 160 about which the dial 150 may rotate. The dial 150 rotates about its central axis 160 that coincides with a central axis 162 of the opening 110 of the chamber 106. In some cases, the dial 150 includes a first surface 164 and a second surface 166 disposed opposite to the first surface 164.

The dial 150 includes a plurality of first orifices 170 arrayed circularly around the dial central axis 160. As shown in FIG. 4, the first orifices 170 may be arranged at a first radial distance d1 from the dial central axis 160. In some cases, the sizes or diameters of the first orifices 170 vary from each other, allowing metering of chemical flow when the sprayer 100 is operated in the wet mode.

The dial 150 also includes a second orifice 176, as depicted in FIG. 3 and FIG. 4. The second orifice 176 may be arranged at a second radial distance from the dial central axis 160. In some cases, one of the first orifices 170 may serve as an exit orifice 178, as shown in FIG. 3.

As illustrated in FIG. 4 and FIG. 5, the dial 150 includes an arcuate slot 184 extending arcuately around the dial central axis 160. The arcuate slot 184 may be arranged at the second radial distance from the dial central axis 160 and facing the cap portion 122. The arcuate slot 184 includes a first end 186 and a second end 188. In some cases, the second orifice 176 may be disposed between the first end 186 and the second end 188 of the arcuate slot 184. The arcuate slot 184 may be a blind slot that extends from the second surface 166 towards the first surface 164 of the dial 150. The arcuate slot 184 is formed as a recess in the second surface 166 of the dial 150, creating a pathway through which air can flow to prevent a vacuum from forming in the tank 102 when the sprayer 100 is used with wet chemicals. As shown in FIG. 3, the first surface 164 of the dial 150 reveals that there is no gap or opening extending through the dial 150 where the arcuate slot 184 is present. Consequently, when the arcuate slot 184 is aligned over the second cap port 172, fluid may be blocked from entering into the tank 102. In some aspects, fluid may only enter into the tank 102 when the second orifice 176 is aligned with the second cap port 172.

In some cases, the diameter of the second orifice 176 may be the same as the width of the arcuate slot 184. This configuration may allow for consistent fluid flow characteristics between the second orifice 176 and the arcuate slot 184.

The dial 150 includes a retention structure 156, as shown in FIG. 3, FIG. 4, and FIG. 5. The retention structure 156 may be configured to receive a cylindrical protrusion 158 of the cap portion 122 for rotatable engagement. This arrangement allows the dial 150 to rotate relative to the cap portion 122 while maintaining proper alignment.

By rotating the dial 150, the sprayer 100 may be switched between wet and dry modes of operation. In the wet mode, one of the first orifices 170 may align with the first port 140 and first cap port 142 to enable chemical flow from the tank 102 to the channel 112. In the dry mode, the second orifice 176 may align with the second port 174 and second cap port 172 to allow motive fluid to enter the tank 102.

To facilitate the flow of chemical from the chamber 106 to the channel 112, the cap portion 122 may include a first cap port 142. In some cases, the first cap port 142 may extend through the cap portion 122 and may be aligned with the first port 140 to allow the chemical from the tank 102 to flow to the channel 112.

The sprayer head 104 may include various sealing components to prevent leakage of the chemical or motive fluid. In some cases, the sprayer head 104 may include O-rings 171. The O-rings 171 may include an upper first o-ring 171a and a lower first o-ring 171b. The upper first o-ring 171a may be seated in a groove on the channel 112 and may be arranged surrounding the first port 140. The lower first o-ring 171b may be seated in a groove on the cap portion 122 and may be disposed surrounding the first cap port 142.

To operate the sprayer 100 in dry mode for solid chemicals, the cap portion 122 may include a second cap port 172. The second cap port 172 may be aligned with the second port 174 to allow a passage of the motive fluid into the tank 102 from the channel 112.

Similar to the O-rings 171, the sprayer head 104 may include second O-rings 180. The second O-rings 180 may include an upper second o-ring 180a and a lower second o-ring 180b. The upper second o-ring 180a may be seated in a groove on the channel 112 and may be arranged surrounding the second port 174. The lower second o-ring 180b may be seated in a groove on the cap portion 122 and may be disposed surrounding the second cap port 172.

The tube 144 may be connected to the cap portion 122 at a first end thereof. In some cases, the tube 144 may have a second end which extends downward into the tank 102. The first end of the tube 144 may be aligned with the first cap port 142 to direct the chemical from the tank 102 up the tube 144.

The sprayer 100 may be operated in either a wet mode or a dry mode, depending on the type of chemical stored in the tank 102. The operation and interaction of components differ between these two modes.

In wet mode operation, the dial 150 may be rotated to align one of the first orifices 170 with the first port 140 and the first cap port 142. This alignment creates a fluid path from the tank 102 to the channel 112. As motive fluid flows through the channel 112 and the nozzle 126, the convergent portion 132 of the nozzle 126 may increase the velocity of the motive fluid, creating a pressure differential between the channel 112 and the tank 102. This pressure differential may draw liquid chemical from the tank 102 through the tube 144, the first cap port 142, the aligned first orifice 170, and the first port 140 into the channel 112.

In some cases, the arcuate slot 184 on the second surface 166 of the dial 150 may be aligned with the second cap port 172 during wet mode operation. This alignment may allow air to enter the tank 102 through the gap 152 between the dial 150 and the cap portion 122, preventing a vacuum from forming in the tank 102 as liquid chemical is drawn out.

For dry mode operation, the dial 150 may be rotated to align the second orifice 176 with the second port 174 and the second cap port 172. In this configuration, a portion of the motive fluid flowing through the channel 112 may be diverted through the second port 174, the second orifice 176, and the second cap port 172 into the tank 102. This diverted motive fluid may dissolve or mix with the dry chemical in the tank 102.

The resulting chemical solution may then be drawn back into the channel 112 through a similar path as in wet mode operation. The exit orifice 178, which may be one of the first orifices 170, may align with the first port 140 and the first cap port 142 to allow the chemical solution to be drawn up through the tube 144 and into the channel 112.

In both modes of operation, the O-rings 171 and the second O-rings 180 may help prevent leakage between the various components. The upper first o-ring 171a and the lower first o-ring 171b may seal around the first port 140 and the first cap port 142, respectively. Similarly, the upper second o-ring 180a and the lower second o-ring 180b may seal around the second port 174 and the second cap port 172, respectively.

The sprayer head 104 may include an actuator 117 to control the flow of motive fluid through the inlet 114 into the channel 112. A user may operate the actuator 117 to start or stop the flow of motive fluid, thereby controlling the spraying operation.

The sprayer 100 may include a handle 118 to allow a user to hold and direct the sprayer 100 during operation. The handle 118 may be ergonomically designed for comfortable use during extended spraying sessions.

Based upon the foregoing disclosure, it is seen that the present disclosure provides a versatile hose end sprayer that offers significant advantages over prior art designs. The sprayer surpasses existing solutions by incorporating a simple yet effective dial mechanism that allows for seamless switching between wet and dry chemical applications. This dual-mode functionality eliminates the need for separate dedicated sprayers, reducing equipment costs and simplifying chemical application processes for users.

The innovative design of the sprayer enhances user convenience and efficiency. By integrating multiple functions into a single dial component, the sprayer reduces complexity and potential points of failure compared to prior art designs that rely on separate valves or additional components. This simplification not only improves reliability but also minimizes the risk of user error during operation.

Furthermore, the sprayer's metering capabilities, achieved through variably sized orifices in the dial, allow for precise control of chemical flow rates. This feature enhances the sprayer's adaptability to different application requirements and chemical formulations, providing users with greater flexibility and accuracy in their chemical applications.

The sprayer also addresses common issues found in prior art designs, such as vacuum formation in the tank during wet mode operation. The incorporation of an arcuate slot in the dial provides a simple yet effective means of allowing air entry, preventing vacuum formation without the need for additional components. This elegant solution further contributes to the sprayer's overall reliability and ease of use.

In summary, the present disclosure offers a hose end sprayer that combines versatility, simplicity, and efficiency in a single device. By overcoming limitations of prior art designs, this sprayer provides users with a more intuitive, reliable, and cost-effective solution for both wet and dry chemical applications.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1. A sprayer configured to spray a chemical in a wet mode and a dry mode, the sprayer comprising:
a tank adapted to store the chemical;
a sprayer head removably coupled to the tank, the sprayer head including:
a cap portion arranged to cover an opening of the tank and having a first cap port and a second cap port;
a channel arranged above the cap portion and configured to facilitate a flow of a motive fluid through the sprayer head;
a nozzle arranged inside the channel and having a convergent portion to increase velocity of the motive fluid and decrease pressure of the motive fluid downstream of the nozzle to create a pressure difference between the channel and the tank to pull the liquid chemical into the channel from the tank at a location downstream of the nozzle through the first cap port, wherein the second cap port is arranged upstream of the nozzle; and
a dial arranged between the channel and the cap portion, the dial being configured to rotate relative to the cap portion and the channel, the dial including:
a plurality of first orifices arrayed circularly at a first radial distance from a central axis of the dial and configured to align with the first cap port to enable a flow of the chemical from the tank to the channel;
a second orifice arranged at a second radial distance from the central axis of the dial, wherein the second orifice is aligned with the second cap port to allow a passage of the motive fluid inside the tank from the channel to operate the sprayer in the dry mode; and
a slot extending arcuately around the central axis of the dial and arranged at the second radial distance from the central axis and facing the cap portion, wherein the second orifice is disposed between ends of the slot, wherein in the wet mode, the slot is aligned with the second cap port to block the incoming flow of motive fluid from the channel into the tank and enable an entry of air present between the cap portion and the dial through the second cap port.

2. The sprayer of claim 1, further comprising a tube connected to the cap portion at a first end thereof and extending downward into the tank at a second end thereof, wherein the tube is aligned with the first cap port to direct the chemical from the tank.

3. The sprayer of claim 1, wherein the plurality of first orifices have varying diameters to allow metering of the chemical flow to the channel when the sprayer is operated in the wet mode.

4. The sprayer of claim 1, further comprising a first O-ring seated in a groove on the channel and arranged surrounding the first port between an upper surface of the dial and the channel to prevent leakage therebetween.

5. The sprayer of claim 4, further comprising a second O-ring seated in a groove on the cap portion and disposed surrounding the first cap port between a lower surface of the dial and the cap portion.

6. The sprayer of claim 1, further comprising a third O-ring seated in a groove on the channel and arranged surrounding the second port between an upper surface of the dial and the channel to prevent leakage therebetween.

7. The sprayer of claim 6, further comprising a fourth O-ring seated in a groove on the cap portion and disposed surrounding the second cap port between a lower surface of the dial and the cap portion.

8. The sprayer of claim 1, wherein the dial includes a retention structure to receive a cylindrical protrusion of the cap portion to rotatably engage the dial with respect to the cap portion.

9. The sprayer of claim 8, wherein the retention structure is a hollow cylindrical structure.

10. A method of operating a sprayer in a wet mode and a dry mode, the method comprising:
providing a sprayer including a tank for storing a chemical, a sprayer head removably coupled to the tank, the sprayer head having a cap portion with a first cap port and a second cap port, a channel for facilitating a flow of a motive fluid, a nozzle arranged inside the channel, and a rotatable dial arranged between the channel and the cap portion;
rotating the dial to a first position to operate the sprayer in the wet mode, wherein in the first position:
a first orifice of the dial aligns with the first cap port to enable a flow of liquid chemical from the tank to the channel, and
a slot in the dial aligns with the second cap port to block an incoming flow of motive fluid from the channel into the tank and enable an entry of air into the tank; and
rotating the dial to a second position to operate the sprayer in the dry mode, wherein in the second position:
the first orifice of the dial aligns with the first cap port, and
a second orifice of the dial aligns with the second cap port to allow a passage of the motive fluid from the channel into the tank.

11. The method of claim 10, wherein the dial includes a plurality of first orifices arrayed circularly at a first radial distance from a central axis of the dial, and wherein rotating the dial to the first position aligns one of the plurality of first orifices with the first cap port.

12. The method of claim 11, wherein the plurality of first orifices have varying diameters to allow metering of the chemical flow to the channel when the sprayer is operated in the wet mode.

13. The method of claim 10, further comprising providing a tube connected to the cap portion at a first end thereof and extending downward into the tank at a second end thereof, wherein the tube is aligned with the first cap port to direct the chemical from the tank.

14. The method of claim 10, further comprising providing a first O-ring seated in a groove on the channel and arranged surrounding a first port of the channel between an upper surface of the dial and the channel to prevent leakage therebetween.

15. The method of claim 14, further comprising providing a second O-ring seated in a groove on the cap portion and disposed surrounding the first cap port between a lower surface of the dial and the cap portion.

16. The method of claim 15, further comprising providing a third O-ring seated in a groove on the channel and arranged surrounding a second port of the channel between the upper surface of the dial and the channel, and providing a fourth O-ring seated in a groove on the cap portion and disposed surrounding the second cap port between the lower surface of the dial and the cap portion.

17. A dial for use in a sprayer configured to operate in a wet mode and a dry mode, the dial comprising:
a body having a central axis;
a plurality of first orifices arrayed circularly at a first radial distance from the central axis;
a second orifice arranged at a second radial distance from the central axis; and
a slot extending arcuately around the central axis and arranged at the second radial distance from the central axis, wherein the second orifice is disposed between ends of the slot, wherein the dial is configured to rotate between a first position for operating the sprayer in the wet mode and a second position for operating the sprayer in the dry mode.

18. The dial of claim 17, wherein the plurality of first orifices have varying diameters to allow metering of chemical flow when the sprayer is operated in the wet mode.

19. The dial of claim 17, further comprising a retention structure configured to receive a cylindrical protrusion of a cap portion of the sprayer to rotatably engage the dial with respect to the cap portion.

20. The dial of claim 19, wherein the retention structure is a hollow cylindrical structure extending from a surface of the body of the dial.
